(19) United States
(12) Patent Application Publication
(10) Pub. No.: US 2008/0081719 A1
(43) Pub. Date: Apr. 3, 2008

(54) Roller chain sprocket having an improved symmetric tooth form

(76) Inventor: James D. Young, Chesaning, MI (US)

Correspondence Address: FAY SHARPE LLP, 1100 SUPERIOR AVENUE, SEVENTH FLOOR, CLEVELAND, OH, 44114, US

(21) Appl. No.: 11/906,416

(22) Filed: Oct. 2, 2007

Related U.S. Application Data
(63) Continuation-in-part of application No. 11/541,210, filed on Sep. 29, 2006.
(60) Provisional application No. 60/827,920, filed on Oct. 3, 2006.

(51) Int. Cl. F16H 7/00

(52) U.S. Cl. 474/152

(57) ABSTRACT

A reduced noise and vibration chain drive system includes a sprocket with a plurality of symmetrical teeth and tooth spaces. A chain is engaged with the sprocket and includes rollers received in the tooth spaces. The root surface of each tooth space includes a modified root surface portion defined with root relief so that a roller fully seated in said tooth space contacts the root surface at first and second circumferentially spaced apart roller-seating locations but is spaced from the root surface between the first and second roller-seating locations. The sprocket is optionally defined with a reduced chordal pitch as compared to the as-built link pitch of the chain. The roller seating diameter of an inscribed circle tangent to a fully seated roller is greater than a root diameter of the sprocket.

### CROSS-REFERENCE TO RELATED APPLICATIONS

This application claims priority from and benefit of the filing date of U.S. provisional patent application Ser. No. 60/827,920 filed Oct. 3, 2006, and this prior application Ser. No. 60/827,920 is hereby expressly incorporated by reference into the present specification. This application is also a continuation-in-part of U.S. patent application Ser. No. 11/541,210 filed Sep. 29, 2006, and this prior application Ser. No. 11/541,210 is hereby expressly incorporated by reference into the present specification.

### BACKGROUND

Roller chain sprockets used in automotive engine chain drive systems are typically manufactured according to ISO 606: 2004(E) standard (International Organization for Standardization). The ISO 606 standard specifies requirements for short-pitch precision roller chains and associated chain wheels or sprockets. As shown in FIG. 1, the sprocket 10 includes only an ISO 606 tooth form T that is symmetrical with respect to the tooth space TS and has a constant root or roller seating surface 14 which is concave and defined as a circular arc segment by a radius Rᵢ extending from one convex tooth flank 16a to the adjacent or facing convex tooth flank 16b as defined by the roller seating angle α. Accordingly, each flank radius R_{f} is tangent to Rᵢ at the opposite tangency points TP. A chain (shown diagrammatically in FIG. 1A) with a link pitch P has rollers 15,15a of diameter D_{R} in contact with the tooth root surface 14 at the root diameter RD (the diameter of an inscribed circle tangent to the radially innermost location on the root surface 14), and the fully meshed or seated roller 15 is tangent to the root diameter RD. The ISO sprocket 10 has a chordal pitch also of length P. The pitch circle diameter PD, tip or outside diameter OD, and tooth angle A (equal to 360°/N; N=tooth count) further define the ISO 606 compliant sprocket. For a given direction of sprocket rotation 11, the leading flank 16a of a tooth T is referred to herein as an engaging flank and the trailing flank 16b of that same tooth T is referred to as the disengaging flank, and each tooth T is defined symmetrically about a tooth center TC.

Roller-sprocket impact at the onset of meshing is the dominant noise source associated with roller chain drive systems and it occurs when a chain link row leaves the span and its meshing roller collides with the sprocket tooth. It is believed that multiple roller-sprocket tooth impacts occur during the meshing phenomena and these impacts contribute to the undesirable noise levels associated with roller chain drives. There will be at least two impacts at the onset of meshing, a radial impact as the roller 15 collides with the root surface 14 and a tangential impact as the roller moves into its driving position. It is believed that radial impact(s) will occur first, followed closely by tangential impact(s). Referring to FIG. 1A, the radial impact I_{R} for roller 15a, which is shown at the onset of meshing, is believed to be the major contributor to the chain drive noise level. Accordingly, it is desirable to develop a new and improved roller chain sprocket tooth form to reduce the noise levels associated with roller-sprocket impact at the onset of meshing.

### SUMMARY

In accordance with one aspect of the present development, a chain drive system includes a sprocket comprising a plurality of teeth with tooth spaces defined between each circumferentially successive pair of teeth. Each of the tooth spaces defined at least by opposing first and second convex tooth flanks and a concave root surface extending between the convex tooth flanks. The plurality of teeth are symmetrically defined about respective tooth centers evenly spaced from each other at a tooth angle such that each of the tooth spaces is symmetrically defined. A chain is engaged with the sprocket, and the chain includes rollers that are respectively received in the tooth spaces. The root surface of each tooth space comprises a modified root surface portion defined with root relief so that a roller fully seated in the tooth space contacts the root surface at first and second circumferentially spaced apart roller-seating locations, but is spaced from the root surface between the first and second circumferentially spaced apart locations. The fully seated roller includes a roller center located on a pitch diameter.

In accordance with another aspect of the present development, a sprocket includes a plurality of teeth with tooth spaces defined between each circumferentially successive pair of teeth. Each of the tooth spaces is defined at least by opposing first and second convex tooth flanks and a concave root surface extending between the convex tooth flanks. The plurality of teeth are symmetrically defined about respective tooth centers evenly spaced from each other at a tooth angle such that each of the tooth spaces is symmetrically defined. The sprocket is adapted to mesh with an associated chain such that rolling or non-rolling rollers of the associated chain are received in respective ones of said tooth spaces. Each of said tooth spaces is defined with a modified root surface portion adapted to contact a fully seated roller of the associated chain at first and second circumferentially spaced apart roller-seating locations, and adapted to be spaced from the fully seated roller between the first and second roller seating locations.

In accordance with another aspect of the present invention, a sprocket includes a plurality of teeth with tooth spaces defined between each circumferentially successive pair of teeth. Each of the tooth spaces is defined at least by opposing first and second convex tooth flanks and a concave root surface extending between the convex tooth flanks. The plurality of teeth are symmetrically defined about respective tooth centers evenly spaced from each other at a tooth angle such that each of the tooth spaces is symmetrically defined. The sprocket defines a roller seating diameter that is greater than a root diameter.

### BRIEF DESCRIPTION OF DRAWINGS

The invention comprises various components and arrangements of components, preferred embodiments of which are illustrated in the accompanying drawings wherein:

FIG. 1 is a partial front view of a conventional ISO 606 compliant roller chain sprocket;

FIG. 1A is an enlarged illustration of the FIG. 1 sprocket showing a roller at the onset of meshing;

FIG. 2 partially illustrates a sprocket with root relief formed in accordance with one aspect of the present development;

FIG. 2A is an enlarged illustration of the FIG. 2 sprocket showing a roller at the instant of 2-point meshing impact;

FIG. 3 is an overlay of the ISO 606 tooth form shown in FIG. 1 with the tooth form shown in FIG. 2;

FIG. 4 is a partial front view of a sprocket defined with chordal pitch reduction and root relief in accordance with another aspect of the present development;

FIG. 5 is an overlay of the ISO 606 tooth form shown in FIG. 1 with the tooth form shown in FIG. 4;

FIG. 6A is an enlarged illustration of the FIG. 4 tooth form showing a roller at the onset of meshing having initial meshing contact;

FIG. 6B is an enlarged illustration of the FIG. 4 tooth form showing a roller at the instant of 2-point meshing impact;

FIG. 7 shows a chain drive system in accordance with the present development.

### DETAILED DESCRIPTION OF THE INVENTION

The present invention is directed to a new sprocket for a roller chain and a drive system including one or more sprockets formed in accordance with the present invention drivingly engaged with a roller chain. The chain and portions thereof described herein are conventional in all respects unless otherwise noted or shown. The term “roller” as used herein with respect to a chain encompasses both rotating and non-rotating members, e.g., a rotatable sleeve carried on a non-rotatable bushing or other location/member, or simply a non-rotatable bushing or other member itself without any rotatable sleeve carried thereon such as used for a bush chain. Accordingly, the term “roller chain” is intended to encompass a chain with rotatable rollers or a “bush chain” wherein the “rollers” are merely non-rolling bushings or other non-rotatable members.

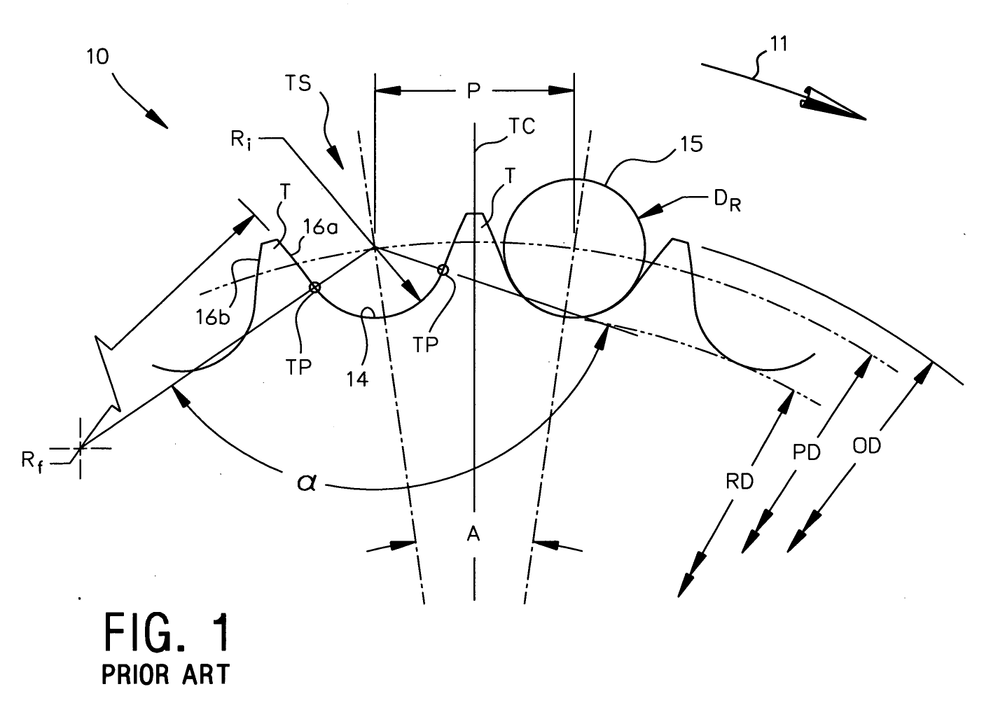

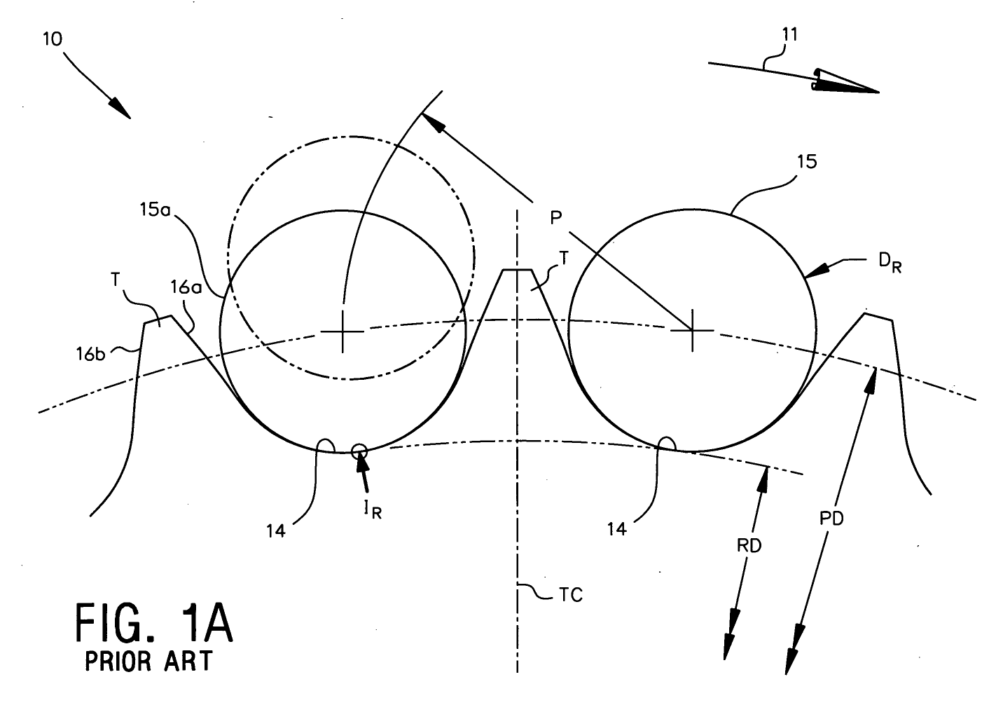

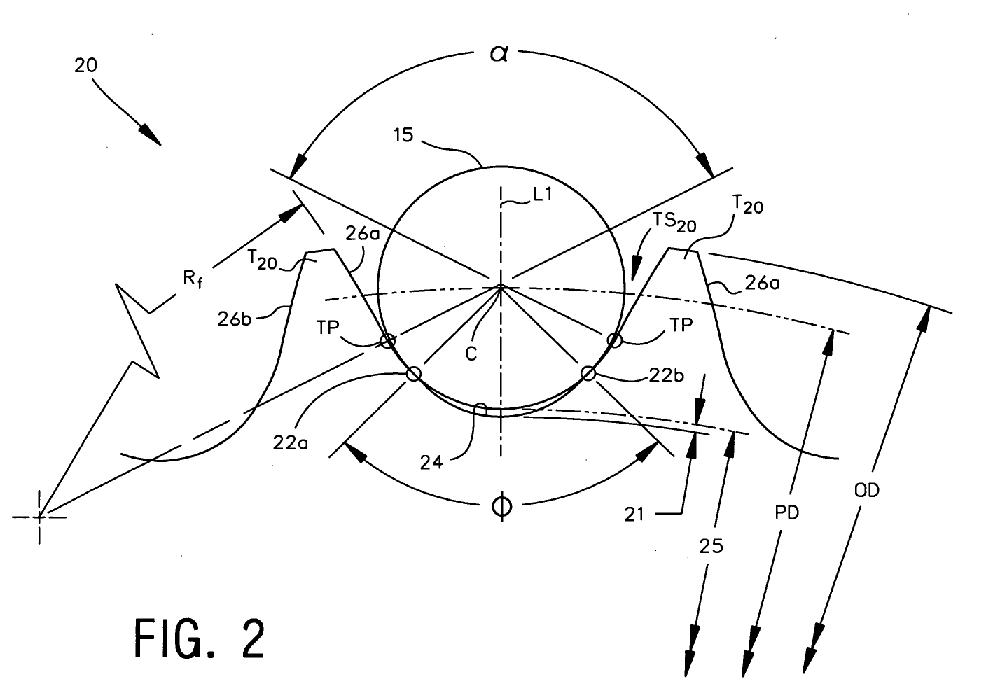

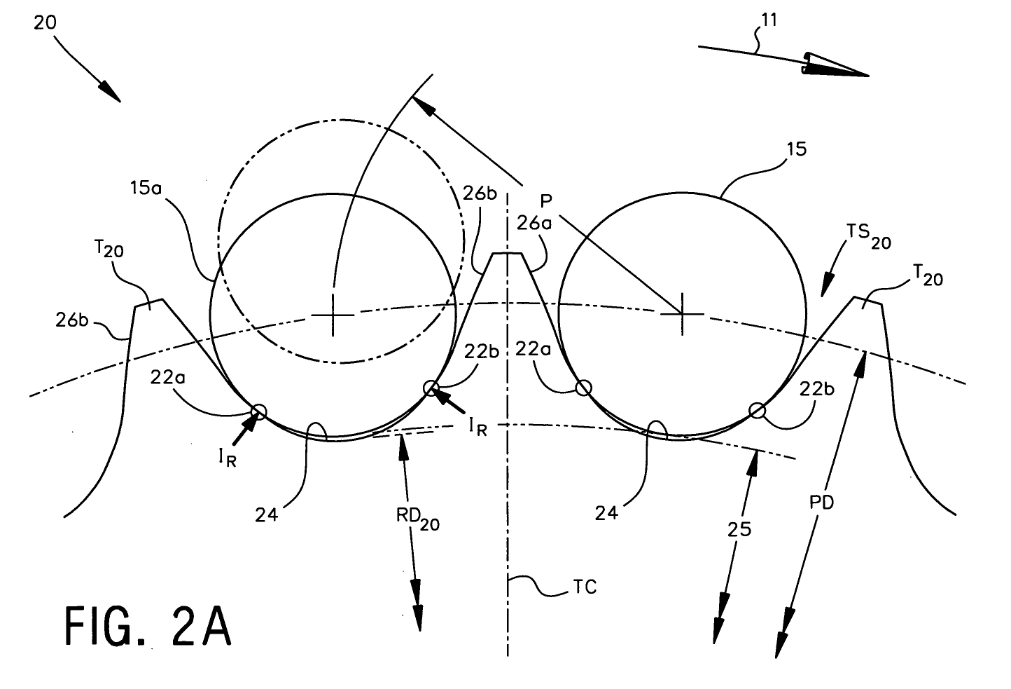

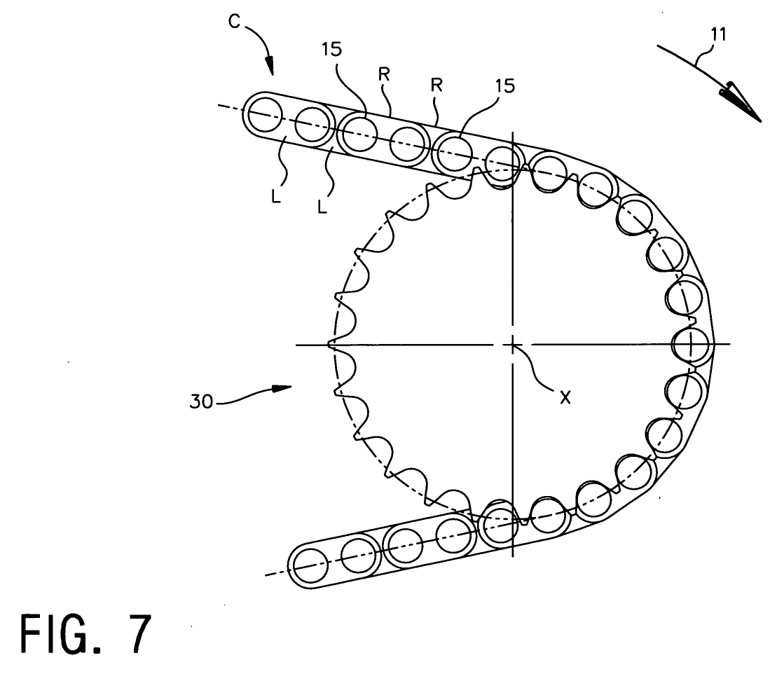

FIG. 2 partially shows a sprocket 20 formed in accordance with a first embodiment of the present development. As compared to the sprocket 10 shown in FIGS. 1 and 1A, the sprocket 20 is modified to include “root relief,” i.e., to define a modified concave root surface 24 that provides 2-point contact at roller seating locations 22a,22b when a chain roller 15 is fully seated in the root of the tooth space TS₂₀ (those of ordinary skill in the art will understand that locations 22a,22b are lines of contact that extend across a thickness of the root surface 24). A clearance space 21 is thus defined between the fully seated roller 15 and the modified root surface 24 between the contact locations 22a,22b. A reference line L1 that passes through the center C of the fully seated roller 15 and also through the sprocket axis of rotation X (see FIG. 7) symmetrically bisects the tooth space TS₂₀ and symmetrically bisects distance between the roller seating locations 22a,22b.

Referring now also to FIG. 2A, the roller 15 is shown in a fully meshed (2-point) driving position and the next meshing roller 15a is shown at the instant of meshing impact at locations 22a,22b. The 2-point contact at these contact locations 22a,22b effectively serves to spread the initial radial impact I_{R} over a larger contact area as compared to the sprocket 10 which will exhibit single-point contact for the radial impact I_{R}.

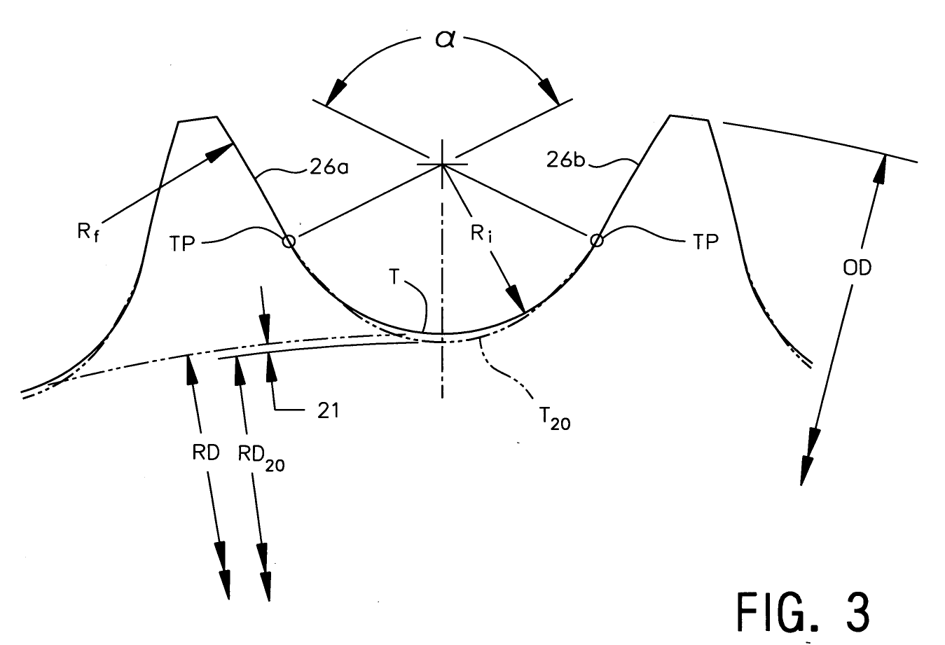

As shown in the FIG. 3 overlay of the tooth forms T,T₂₀ of the sprockets 10,20, respectively, it is apparent that the profile difference is in the roller seating angle α region only, radially inward from and circumferentially between the tangency points TP. The flank radii R_{f} for both convex flanks 26a,26b, the outside diameter OD, and the pitch diameter PD for the tooth form T₂₀ are respectively identical to the tooth form T for the ISO 606 compliant sprocket 10. Referring now to all of FIGS. 2, 2A, and 3, there is “root relief” or an open clearance space 21 defined between a roller 15 and the modified root surface 24 when the roller 15 is fully seated and in contact with roller seating locations 22a,22b of the sprocket 20. As such, the root diameter RD₂₀ of the sprocket 20 is smaller than the root diameter RD of the sprocket 10 owing to this root relief, but the radial position of the fully seated roller 15 is unchanged as between the sprockets 10,20. The angle φ (FIG. 2) has a vertex at the roller center C and locates the roller seating locations 22a,22b between which the roller 15 bridges the root surface 24, and this angle is preferably 90°, but may be in the range of 75° to 100°. It is important to note that the roller 15 is in the same radial position (with its center C also on the pitch circle PD) as a fully meshed roller with the ISO 606 compliant sprocket tooth form 10. Accordingly, the sprocket 20 defines or exhibits a roller seating diameter 25, which is defined as the diameter of the inscribed circle tangent to a roller 15 seated on roller-seating locations 22a,22b, and this roller seating diameter 25 is equal to the root diameter RD of a standard ISO sprocket 10, but is larger than the root diameter RD₂₀ of the sprocket 20. In other words, the only functional difference for sprocket 20 as compared to the conventional sprocket 10 is the 2-point roller contact at points 22a,22b and the related root relief clearance space 21, without any radial inward movement of the fully-meshed roller 15 as compared to the standard ISO sprocket 10. The modification to the roller seating angle α region to provide the 2-point contact at locations 22a,22b and related root relief 21 may be accomplished by combining straight line segments with circular arc segments, and/or involute segments, i.e., the shape of the root surface 24 between the contact points 22 can vary given that the roller 15 makes no contact with this surface. The tooth space TS₂₀ of the sprocket 20 as defined by the flank radii R_{f} and modified root surface 24 is symmetrical, with all line segments, etc. being tangent to adjacent segments in order to provide a smooth transition and tooth form, and this modified root surface 24 will also be tangent to the flank radii R_{f} at the points TP so that the tooth form T₂₀ for the sprocket 20 will precisely overlay the tooth T form for the sprocket 10 outward from the tangency points TP to the tip or outside diameter OD.

As shown above in FIGS. 1 and 1A, the chain link pitch P for a minimum “as-manufactured” (new or unworn) roller chain is equal to the chordal pitch P for a roller chain sprocket such as the sprocket 10 having a maximum as-manufactured tooth form. This equality for chain pitch P and sprocket chordal pitch P exists only at the aforementioned limits of the manufacturing tolerance range, and as the relevant chain and sprocket tolerances vary toward the opposite end of their respective manufacturing limits, there will be a pitch mismatch between chain link pitch and sprocket chordal pitch, with the chain link pitch being greater than the sprocket chordal pitch. In other words, the chain link pitch will always be slightly greater than sprocket chordal pitch except at the specified manufacturing tolerance limits as noted.

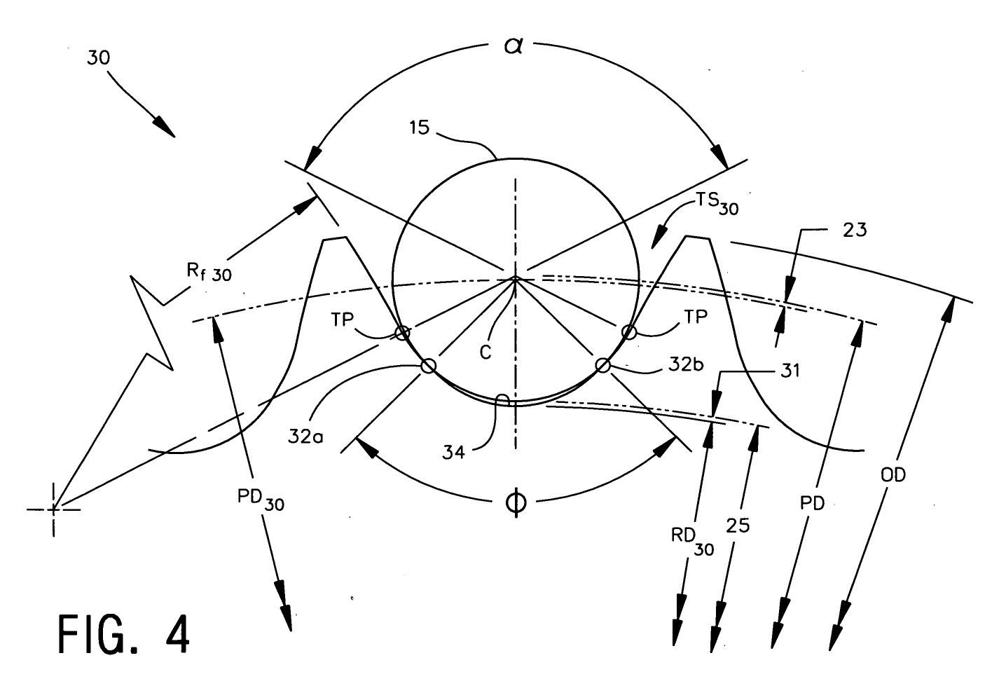

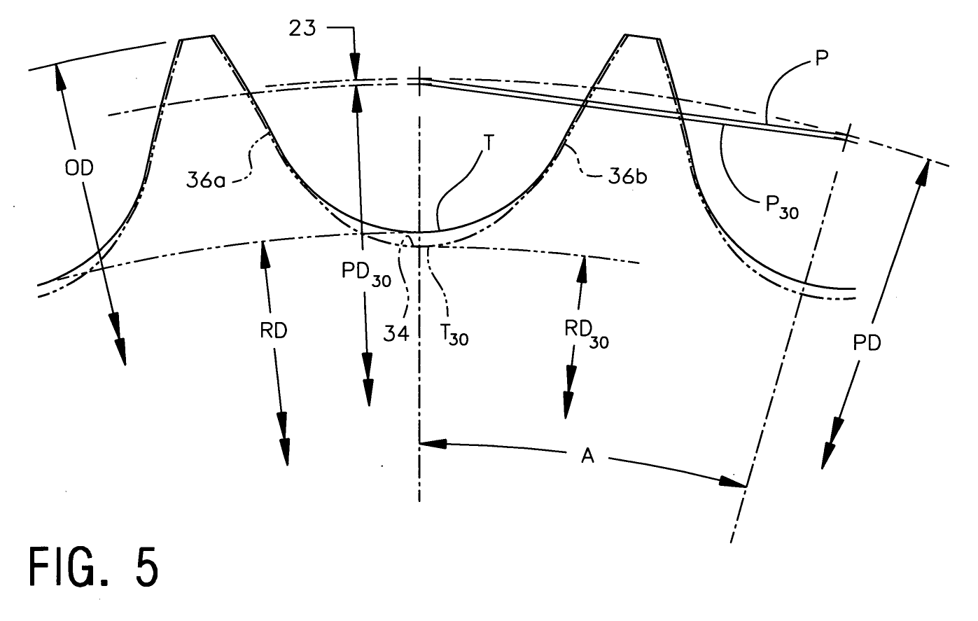

FIG. 4 illustrates a sprocket 30 formed in accordance with an alternative embodiment, which includes added chordal pitch reduction (referred to herein as “added CPR”) i.e., sprocket chordal pitch reduction that is greater than the inherent pitch mismatch between the sprocket and chain as described above, in addition to the previously defined root relief 21. This sprocket 30 is identical to the sprocket 20 except the tooth profile T₃₀ is also shifted radially inward (see the overlay with the conventional sprocket 10 in FIG. 5) as a result of the added CPR, thereby introducing pitch mismatch between the chain link pitch P and sprocket chordal pitch P₃₀ as shown in FIG. 5 with chordal pitch P₃₀ being shorter than the standard chain and sprocket chordal pitch P by an amount greater than that resulting from manufacturing tolerances. The sprocket chordal pitch P₃₀ is less than the chain link pitch P by an amount equal to at least 0.4% up to 1% of the as-built (unworn) chain link pitch P.

Referring to FIG. 5, the added chordal pitch reduction in accordance with the present development is diagrammatically illustrated in which a standard ISO 606 chordal pitch P on pitch diameter PD is compared to the reduced chordal pitch P₃₀ of the sprocket 30 on the smaller pitch diameter PD₃₀. The magnitude of the radial difference 23 between the standard pitch diameter PD of a standard ISO sprocket 10 and the pitch diameter PD₃₀ of the sprocket 30 provides another means for measuring the magnitude of the added chordal pitch reduction. The outside diameter OD and roller seating angle α of the sprocket 30 are identical to the standard sprocket 10, and the magnitude of the flank radii R_{f 30} for the flanks 36a,36b may or may not be the same as the magnitude of the radii R_{f} of the corresponding flanks 16a,16b for the sprocket 10. Referring again to FIG. 4, roller 15 is shown to be fully meshed and seated on contact points 32a,32b with its center C shifted radially inward on the smaller diameter pitch diameter PD₃₀, which is smaller than the standard ISO 606 pitch diameter PD of the sprockets 10 and 20. A root relief clearance 31 is defined between the roller 15 and the relieved root surface 34 so that the roller 15 bridges the root surface 34 between trailing and leading roller seating locations 32a,32b. The root diameter R₃₀ of the sprocket 30 is smaller than the root diameter R₂₀ of the root relief sprocket 20 without the added CPR.

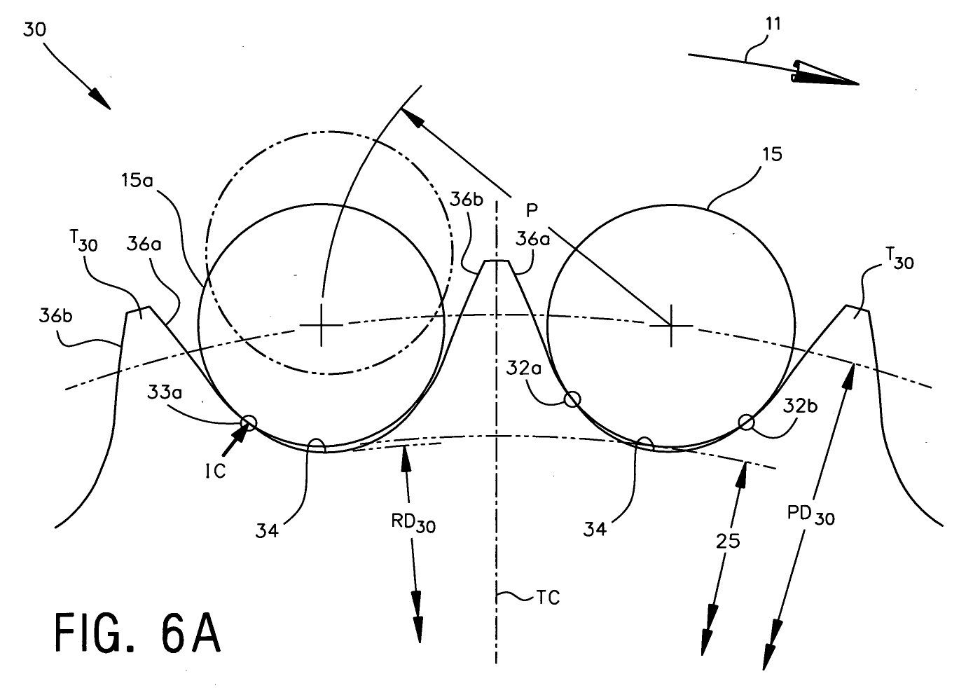

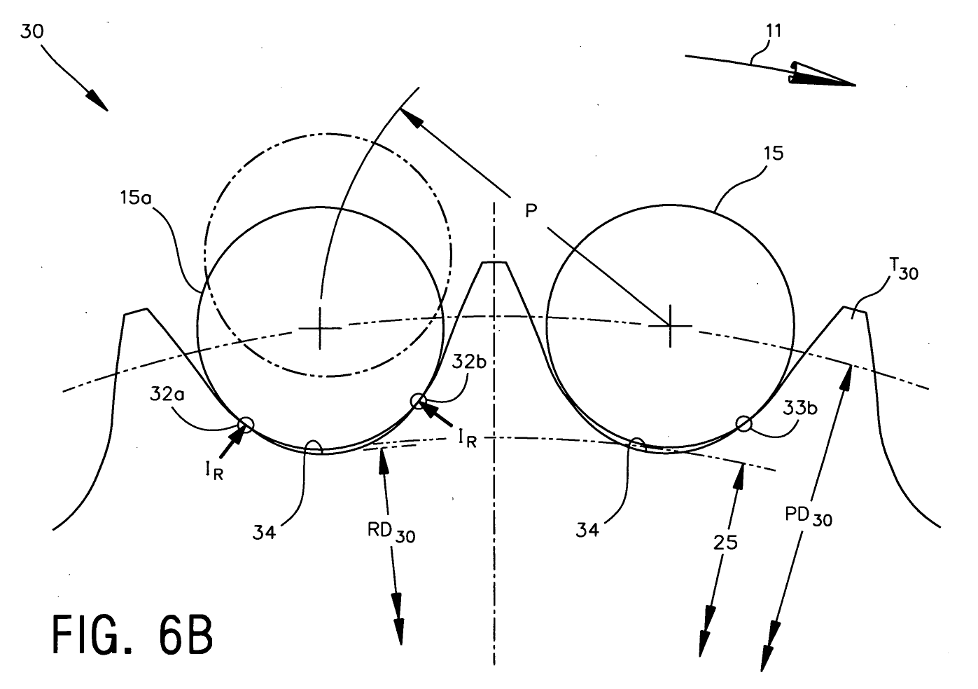

Referring now to FIG. 6A, the sprocket 30 is rotating in direction 11 and the leading roller 15 is seated in 2-point contact at trailing and leading roller-seating locations 32a,32b. The meshing roller 15a is shown at an instant of single-point meshing impact IC at an initial contact point 33a as a result of the pitch mismatch. The initial contact point 33a is located radially outward from the trailing roller seating locations 32a. As the roller engagement phenomenon continues as shown in FIG. 6B, the meshing roller 15a will then make 2-point radial impact I_{R} at contact points 32a,32b, and may rebound and have multiple impacts before finally moving into driving position. Owing to the pitch mismatch, as the roller 15a meshes in this staged manner, the preceding roller 15 is pushed forward slightly into single point contact at point 33b located slightly radially outward from the leading roller seating location 32b on the disengaging (trailing) side of the preceding sprocket tooth. This staged meshing phenomenon leads to reduced noise and vibration as the chain meshes with the sprocket 20.

FIG. 7 shows a chain drive system in accordance with the present development. The chain C is conventional in all respects and includes rows R of link plates L and (rotatable or non-rotatable) rollers 15. The chain is drivingly engaged with the sprocket 30, with rollers 15 received in the tooth spaces TS thereof. The sprocket 30 rotates about an axis of rotation X.

The claims, as originally presented and as they may be amended, encompass variations, alternatives, modifications, improvements, equivalents, and substantial equivalents of the embodiments and teachings disclosed herein.

1. A chain drive system comprising:
a sprocket comprising a plurality of teeth with tooth spaces defined between each circumferentially successive pair of said teeth, each of said tooth spaces defined at least by opposing first and second convex tooth flanks and a concave root surface extending between said convex tooth flanks, wherein said plurality of teeth are symmetrically defined about respective tooth centers evenly spaced from each other at a tooth angle such that each of said tooth spaces is symmetrically defined;
a chain engaged with said sprocket, said chain comprising rollers that are respectively received in said tooth spaces;
wherein said root surface of each tooth space comprises a modified root surface portion defined with root relief so that a roller fully seated in said tooth space: (i) contacts said root surface at first and second circumferentially spaced apart roller-seating locations; (ii) is spaced from said root surface between said first and second circumferentially spaced apart locations; and, (iii) includes a roller center located on a pitch diameter.

2. The chain drive system as set forth in claim 1, the roller center of said fully seated roller and an axis of rotation about which said sprocket rotates are oriented such that a reference line extending through both said roller center and said axis of rotation symmetrically bisects said tooth space in which said roller is fully seated and symmetrically bisects a circumferential distance between the first and second roller seating locations.

3. The chain drive system as set forth in claim 1, wherein said modified root surface portion is defined by a root circular arc segment that extends through said first and second circumferentially spaced-apart roller-seating locations.

4. The chain drive system as set forth in claim 3, wherein said root circular arc segment is tangent to both said first and second convex tooth flanks.

5. The chain drive system as set forth in claim 4, wherein said first and second convex tooth flanks are defined by respective first and second flank circular arc segments.

6. The chain drive system as set forth in claim 1, wherein said rollers of said chain are provided by a non-rotating bushing.

7. The chain drive system as set forth in claim 1, wherein said rollers of said chain comprises a bushing on which a cylindrical roller sleeve is rotatably supported.

8. The chain drive system as set forth in claim 1, wherein said first and second roller-seating locations define therebetween an angle of between 75 degrees and 100 degrees, with a vertex located at said center of said fully seated roller.

9. The chain drive system as set forth in claim 1, wherein said sprocket defines a chordal pitch that is shorter than a link pitch of the chain.

10. The chain drive system as set forth in claim 9, wherein said sprocket chordal pitch is less than said chain link pitch by at least 0.4% of said chain link pitch but not more than 1% of said chain link pitch.

11. The chain drive system as set forth in claim 10, wherein a downstream roller immediately preceding said fully seated roller contacts said sprocket a single location located radially outward from said first and second roller seating locations.

12. The chain drive system as set forth in claim 1, wherein a roller seating diameter of an inscribed circle tangent to the fully seated roller is greater than a root diameter of the sprocket.

13. A sprocket comprising:
a plurality of teeth with tooth spaces defined between each circumferentially successive pair of said teeth, each of said tooth spaces defined at least by opposing first and second convex tooth flanks and a concave root surface extending between said convex tooth flanks, wherein said plurality of teeth are symmetrically defined about respective tooth centers evenly spaced from each other at a tooth angle such that each of said tooth spaces is symmetrically defined;
said sprocket adapted to mesh with an associated chain such that rolling or non-rolling rollers of the associated chain are received in respective ones of said tooth spaces;
each of said tooth spaces defined with a modified root surface portion adapted to contact a fully seated roller of the associated chain at first and second circumferentially spaced apart roller-seating locations, and adapted to be spaced from the fully seated roller between the first and second roller seating locations.

14. The sprocket as set forth in claim 13, wherein said sprocket defines a roller seating diameter that is greater than a root diameter.

15. The sprocket as set forth in claim 14, wherein said modified root surface portion is defined by a root circular arc segment that extends through said first and second circumferentially spaced-apart roller-seating locations.

16. The sprocket as set forth in claim 15, wherein said root circular arc segment is tangent to both said first and second convex tooth flanks.

17. The sprocket as set forth in claim 16, wherein said first and second convex tooth flanks are defined by respective first and second flank circular arc segments.

18. The sprocket as set forth in claim 13, wherein said sprocket defines a chordal pitch that is shorter than the link pitch of the associated chain by at least 0.4% of the link pitch but not more than 1% of the link pitch.

19. The sprocket as set forth in claim 1, wherein said first and second roller-seating locations define therebetween an angle of between 75 degrees and 100 degrees, with a vertex located at a center of the fully seated roller of the associated chain.

20. A sprocket comprising:
a plurality of teeth with tooth spaces defined between each circumferentially successive pair of said teeth, each of said tooth spaces defined at least by opposing first and second convex tooth flanks and a concave root surface extending between said convex tooth flanks, wherein said plurality of teeth are symmetrically defined about respective tooth centers evenly spaced from each other at a tooth angle such that each of said tooth spaces is symmetrically defined, wherein said sprocket defines a roller seating diameter that is greater than a root diameter.
